(19) United States
(12) Patent Application Publication
(10) Pub. No.: US 2011/0011239 A1
(43) Pub. Date: Jan. 20, 2011

(54) Tensioning system for musical drum

(76) Inventor: Mark Ellis Stevens, Arlington, WA (US)

Correspondence Address: Mark Stevens, 4031-188 Street N.E., Arlington, WA, 98223, US

(21) Appl. No.: 12/456,575

(22) Filed: Jul. 20, 2009

(51) Int. Cl. G10D 13/02

(52) U.S. Cl. 84/413

(57) ABSTRACT

Unlike other drum tensioning systems, this drum tensioning system has no component directly involved with the tension and tuning of the drum head coming into contact with the shell of the drum. This drum tensioning (tuning) system tunes the drum in an industry standard fashion while greatly reducing the quantity of material in direct contact with the drum, and greatly reducing the area of holes drilled into a drum's shell. In addition, this system eliminates the need for springs, which are the cause of hum and vibration when drum sounds are amplified.

### FIELD OF THE INVENTION

This invention relates generally to mechanics, and more specifically, to a tensioning system for a musical drum.

### BACKGROUND

Musical drums are used by jazz, country, rock, blues, and other musicians to provide rhythm. A drum typically comprises a drum head, a shell, a rim, a plurality of tension rods, and a plurality of lugs. The drum head is disposed over the shell and the rim is disposed over the drum head and about the perimeter of the shell. The rim includes the plurality of tension rods extending therefrom, which are adjustably coupled to the lugs that are fixedly mounted to the shell. Accordingly, the drum is tuned by adjusting the tension rods to pull the rim and the drum head over the shell.

This arrangement suffers from a number of problems, including each of the plurality of lugs being fastened to the shell using two bolts and having a relatively large surface are directly interfacing with the shell. In many drums, up to twenty lugs are coupled to the shell thereby resulting in forty holes in the shell and a cumulatively large contact surface area. Needless to say, this has a negative impact on drum performance. Furthermore, each of the plurality of lugs typically includes springs that cause undesirable vibrational sounds and uses non-locking nuts that increase tuning issues during a performance.

Accordingly, although desirable results have been achieved, there exists much room for improvement. What is needed then is an improved tensioning system for a musical drum.

### BRIEF DESCRIPTION OF THE DRAWINGS

Embodiments of the present invention are described in detail below with reference to the following drawings:

FIG. 1 is a perspective view of a drum shell having a retainer bar disposed thereon, in accordance with an embodiment of the invention;

FIG. 2 is a perspective view of a drum shell having a retainer bar disposed thereon, in accordance with an embodiment of the invention;

FIG. 3 is a perspective view of a drum shell having a retainer bar disposed thereon, in accordance with an embodiment of the invention;

FIG. 4 is a side elevation view of a drum shell having a tension ring disposed against a retainer bar and adjustably coupled to a rim using a tension rod, in accordance with an embodiment of the invention;

FIG. 5 is a side elevation view of a drum shell having a tension ring disposed against a retainer bar and adjustably coupled to a rim using a tension rod, in accordance with an embodiment of the invention;

FIG. 6 is a perspective view of a retainer bar, in accordance with an embodiment of the invention;

FIG. 7 is an exploded view of a retainer bar, in accordance with an embodiment of the invention;

FIG. 8 is a side elevational view of a drum shell having a tension ring disposed against an exposed retainer bar and adjustably coupled to a rim using a tension rod in accordance with an embodiment of the invention

FIG. 9 is a side elevational view of a drum shell having a tension ring disposed against an exposed retainer bar and adjustably coupled to a rim using a tension rod, in accordance with an embodiment of the invention;

FIG. 10 is a top perspective exploded view of a drum shell having a tension ring for disposal against a retainer bar and for adjustably coupling to a rim using a tension rod, in accordance with an embodiment of the invention; and

FIG. 11 is a bottom perspective exploded view of a drum shell having a tension ring for disposal against a retainer bar and for adjustably coupling to a rim using a tension rod, in accordance with an embodiment of the invention.

### DETAILED DESCRIPTION

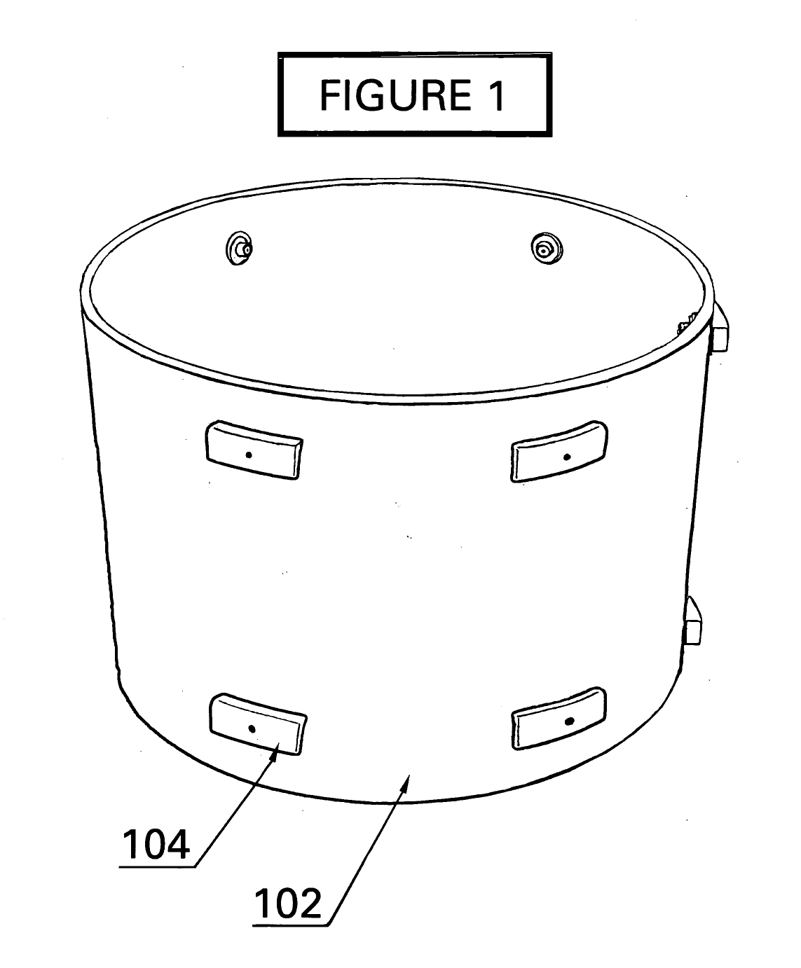

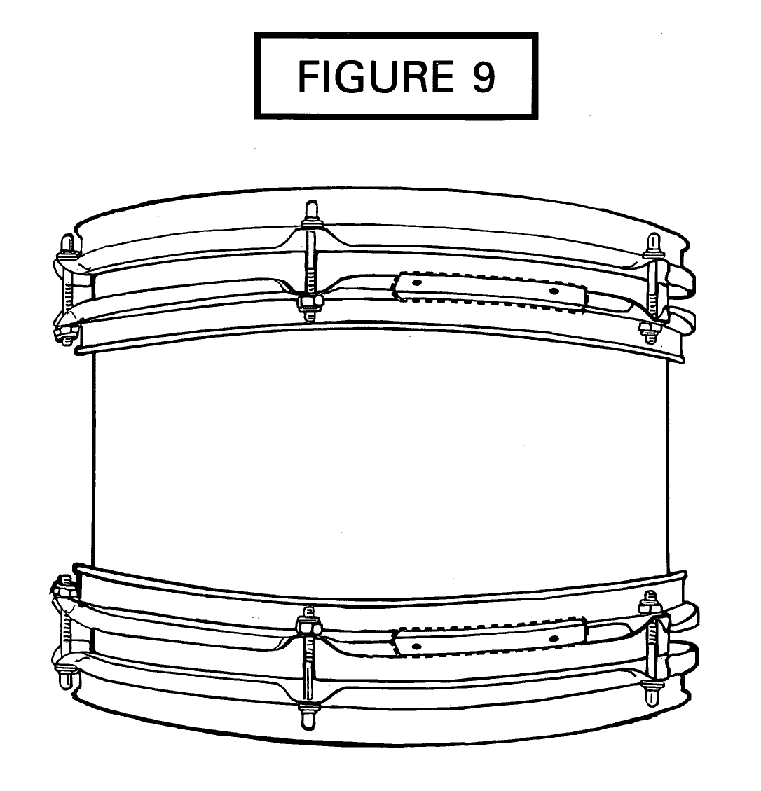

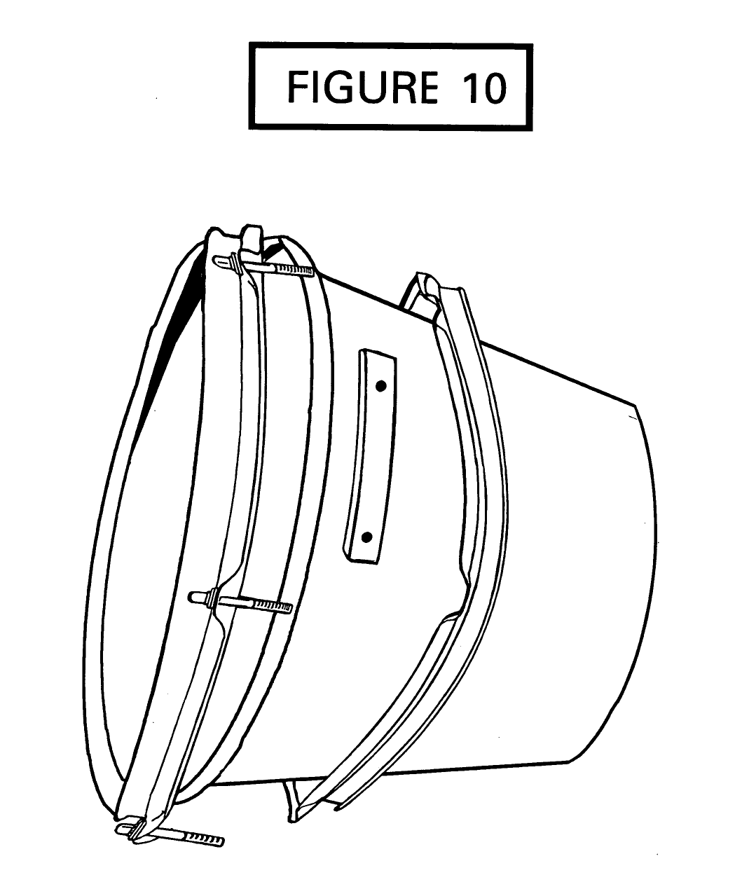

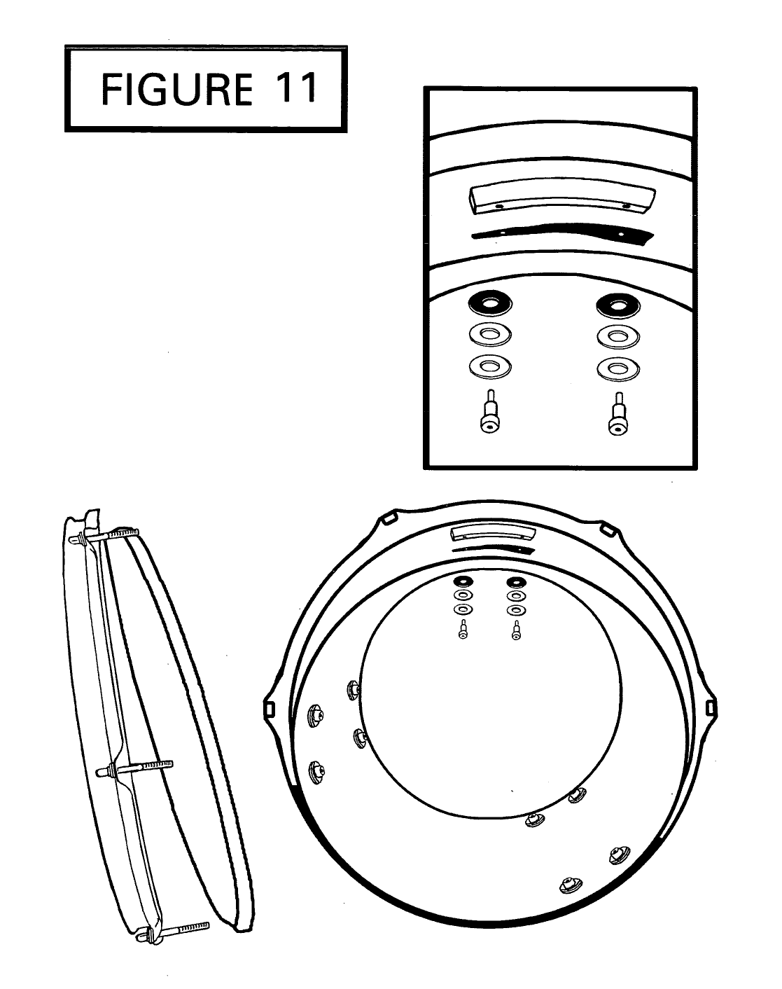

This invention relates generally to mechanics, and more specifically, to a tensioning system for a musical drum. Specific details of certain embodiments of the invention are set forth in the following description and in FIGS. 1-11 to provide a thorough understanding of such embodiments. The present invention may have additional embodiments, may be practiced without one or more of the details described for any particular described embodiment, or may have any detail described for one particular embodiment practiced with any other detail described for another embodiment.

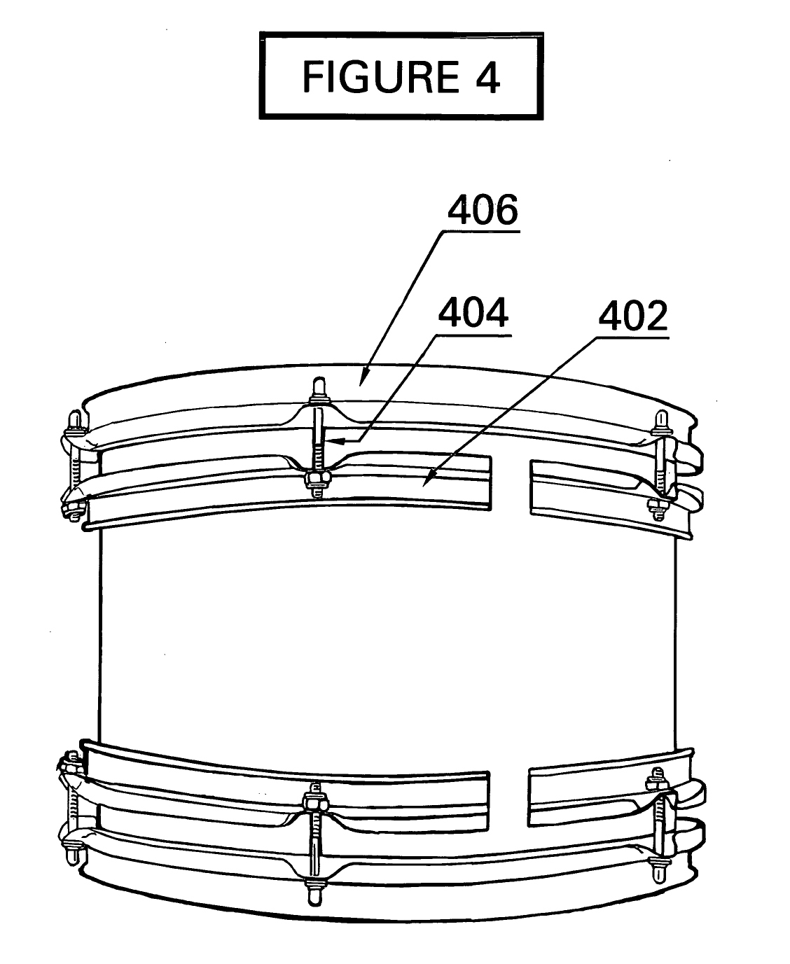

FIGS. 1-3 are perspective views of a drum shell 102 having a retainer bar 104 disposed thereon, in accordance with various embodiments of the invention. The retainer bar is fixedly coupled to the drum shell using at least one fastener and is circumscribedly disposed around and proximate to an end of the shell. The retainer bar is coupled to the drum shell using one ore more washers and compressible pads, which minimize or eliminate the surface area of the retainer bar that is in contact with the shell. The retainer bar is then configurable to receive a tension ring and provide it resistance when the tension rod is tightened relative to the rim (FIG. 4). Accordingly, the retainer bar is separated from and does not directly interface with the tension rod.

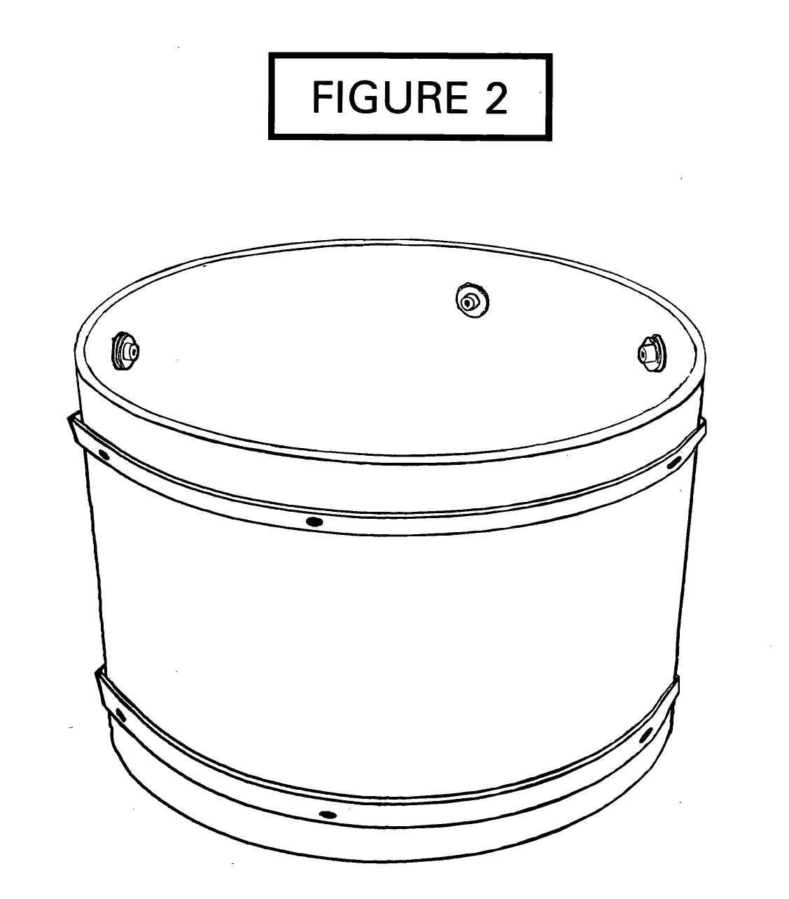

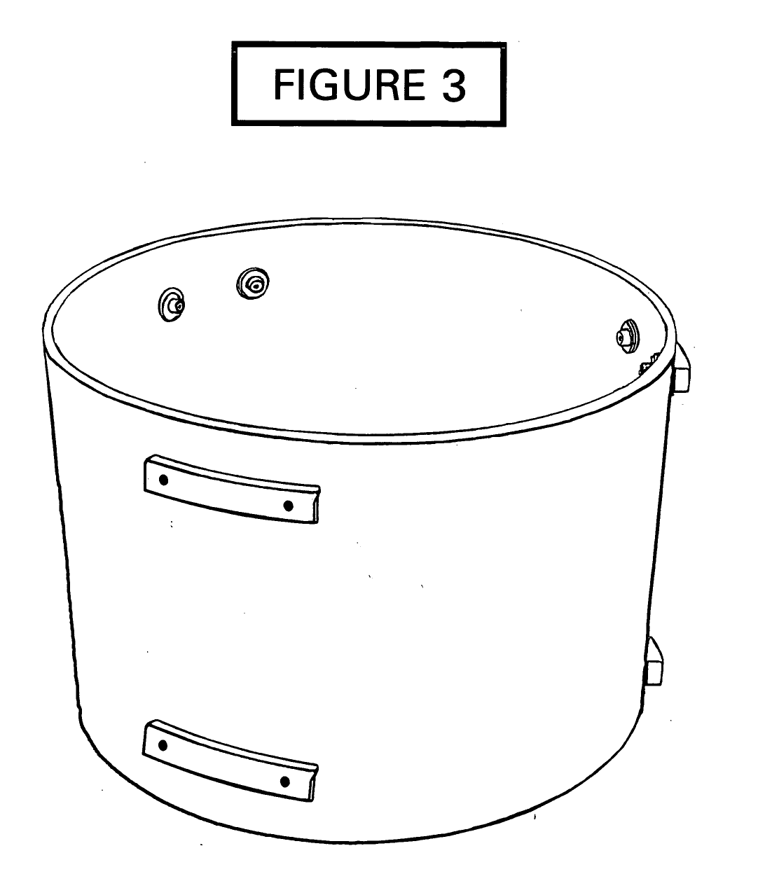

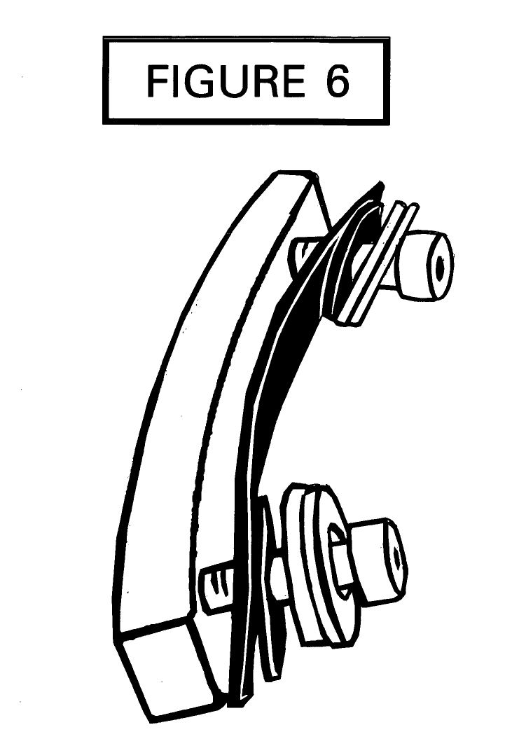

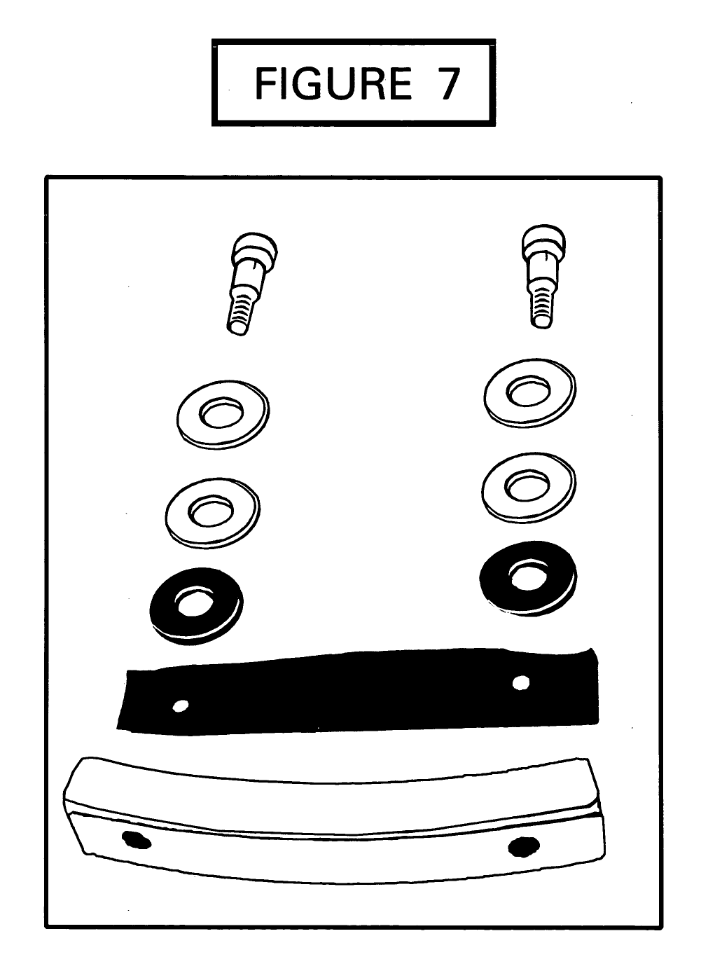

In certain embodiments, the retainer bar is composed of composite, plastic, rubber, metal, wood, other material, or a combination of the foregoing. In alternative embodiments, the retainer bar is composed of a single component that circumscribes the shell (FIG. 2) or a plurality of components that together circumscribe the shell (FIGS. 1, 3), wherein the plurality of components can number one, two, three, or more and may be uniformly or non-uniformly spaced. In one particular embodiment, the retainer bar is disposed more distally or centrally relative to the shell center and may be identically or differently duplicated on an opposing end of the shell as illustrated. In another embodiment, the retainer bar is coupled to the shell using a plurality of fasteners. In various embodiments, the one or more fasteners include adhesive, bolts, screws, nails, nuts, hooks, or any other similar fasteners. The fasteners can be complemented with any arrangement of washers and compressible pads, including the following arrangements: (1) bold, washer, pad, shell, pad, washer, retainer bar; (2) bolt, shell, retainer bar; and (3) nut, shell, retainer bar, bolt (FIGS. 6, 7).

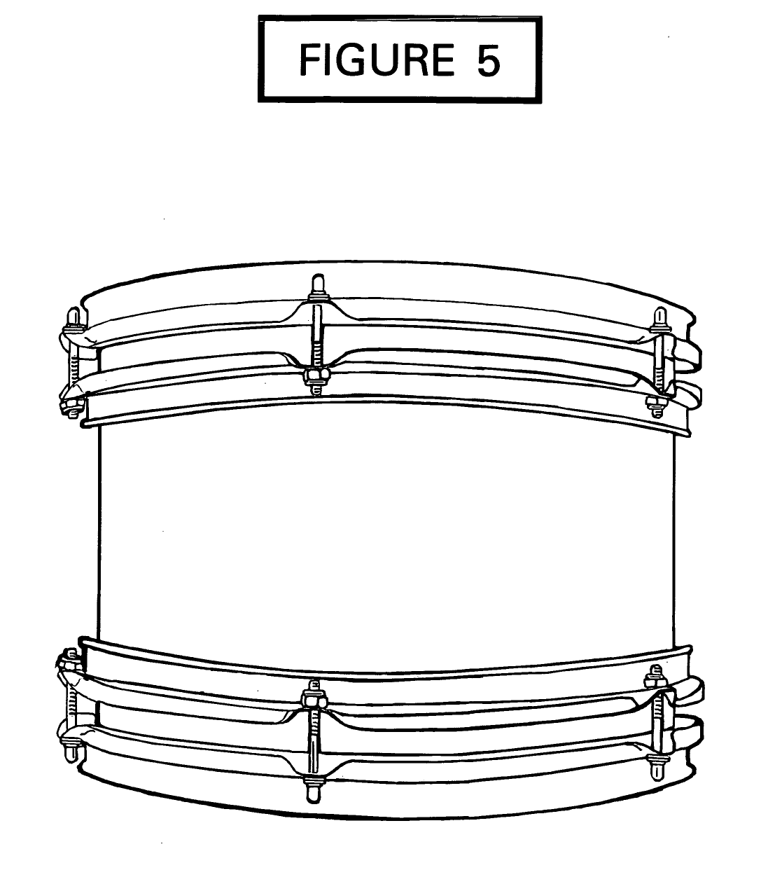

FIGS. 4 and 5 are side elevational views of a drum shell having a tension ring 402 disposed against a retainer bar and adjustably coupled to a rim 406 using a tension rod 404, in accordance with various embodiments of the invention. The retainer bar is fixedly coupled to the drum shell and is circumscribedly disposed around the shell (FIGS. 1-3). The tension ring circumscribes the shell and is disposed against the retainer bar. However, the tension ring is separated form and is not in contact with the shell. The tension rod extends from the tension ring and is adjustably coupled with the rim. Accordingly, the retainer bar is configurable to separate the shell from the tension ring and to provide resistance against the tension ring when the tension rod is tightened relative to the rim. Thus, a drum head is tightened by disposing the rim over the head and tightening the tension rod relative to the tension ring and rim.

In certain embodiments, the tension ring is composed of composite, plastic, rubber, metal, wood, other material, or a combination of the foregoing. In other embodiments, the tension ring is composed of a single component that circumscribes the shell (FIG. 5) or a plurality of components that together circumscribe the shell (FIG. 4), wherein the plurality of components can number one, two, three, or more and may be uniformly or non-uniformly spaced. In one particular embodiment, a spacer or compressible material interfaces between the tension ring and the retainer bar. In a further embodiment, the tension ring is directly coupled to the shell using a fastener, which may also include any combination of washers and compressible pads. In an alternative embodiment, the retainer bar or tension ring is fastened to itself by a member that extends through the shell. In another embodiment, the tension ring is anchored to the retainer bar. In another embodiment, the tension ring is identically or differently duplicated on an opposing end of the shell as illustrated. In further embodiments, the tension ring includes a hold for receiving the tension rod, which may be threaded, or the tension ring includes the tension rod itself. In yet another embodiment, the tension rod is a bolt that includes threads of any size, including the standard 24 threads per inch, 32 threads per inch, or another non-standard size and includes a locking or non-locking nut (nylock). In other embodiments, the tension rod is replaced with any other fastener. In a further embodiment, a plurality of tension rods are employed.

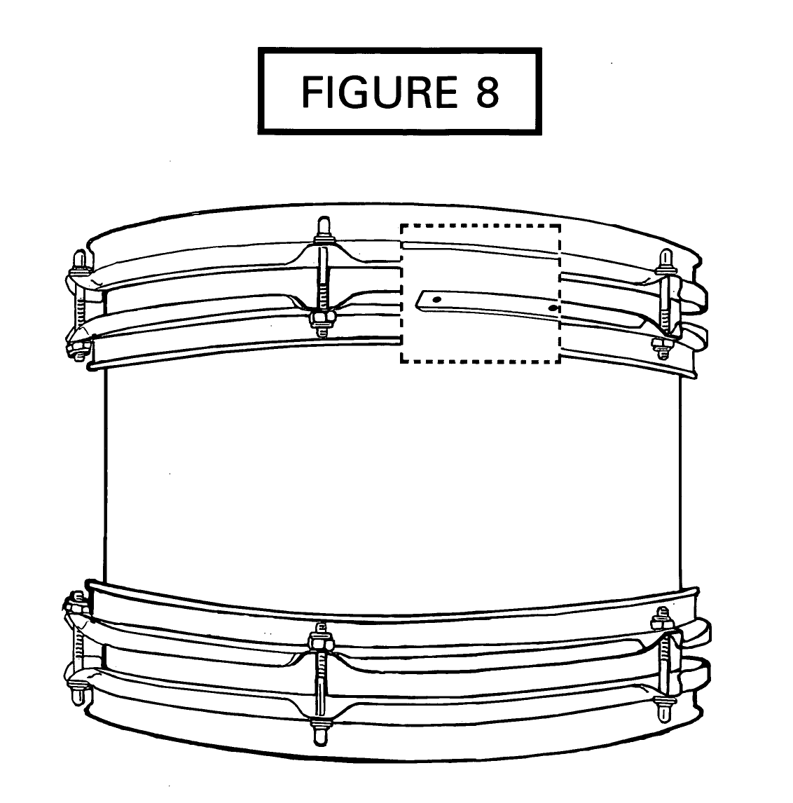

FIGS. 8-11 provide additional detailed views of various embodiments of the invention.

While preferred and alternate embodiments of the invention have been illustrated and described, as noted above, many changes can be made without departing from the spirit and scope of the invention. Accordingly, the scope of the invention is not limited by the disclosure of these preferred and alternate embodiments. Instead, the invention should be determined entirely by reference to the claims that follow.

1. I claim a drum tensioning system which eliminates the need for drum lugs (a drum lug is an apparatus attached to the drum shell which contains threads to receive tension rods) while maintaining the standard method of musical drum head tensioning (tuning); the standard method of drum head tuning uses several tension rods (also known as tuning rods), spaced at intervals around the drum, which go through ears on drum hoops (also known as rims) and use tension to tighten the drum head to the drum body.

2. I claim a tensioning system according to claim 1, wherein the tensioning system eliminates the use of drum lugs while maintaining the ability to tune drums by applying variable tension at intervals around the drum.

3. I claim a tensioning system according to claim 1, wherein the tensioning system eliminated drum lugs without eliminating the use of hoops and tension rods to tune drums

4. I claim a tensioning system according to claim 1, wherein the tensioning system greatly reduces the area on a drum shell which is in contact with external items, and this reduced contact improves the intrinsic sound of the drum.

5. I claim a tensioning system according to claim 1, wherein the tensioning system greatly decreased the area on the side of a drum shell that has holes drilled into it, which improves the intrinsic sound of the drum.

6. I claim a tensioning system according to claim 1, wherein the drum tensioning (tuning) system partially or fully circles the drum shell while contacting the drum shell in as few as two places, yet is able to spread the tuning tension around the drum in a very even fashion.

7. I claim a tensioning system according to claim 1, wherein the drum tensioning (tuning) system contacts the drum shell in as few as two places, yet is able to spread the tuning tension around the drum in several places and uses several tension rods to ultimately anchor the drum hoop to the drum head for tuning.
